(19) United States
(12) Patent Application Publication
(10) Pub. No.: US 2017/0207742 A1
(43) Pub. Date: Jul. 20, 2017

(54) METHOD AND ARRANGEMENT FOR MOUNTING SOLAR MODULES ON A SURFACE AREA

(71) Applicant: HPF GmbH, Eisenberg (DE)

(72) Inventor: Helmut Roppelt, Karlsruhe (DE)

(21) Appl. No.: 15/329,520

(22) PCT Filed: Jun. 11, 2015
(86) PCT No.: PCT/EP2015/001169

§ 371 Date: Jan. 26, 2017

(30) Foreign Application Priority Data
Jul. 28, 2014 (DE) 10 2014 010 949.6

(51) Int. Cl. H02S 20/10; H02S 20/22; H02S 20/24

(52) U.S. Cl. CPC H02S 20/10; H02S 20/24; H02S 20/22

(57) ABSTRACT

A method for mounting photovoltaic solar modules (2), in particular thin-layer solar modules, on a surface area (4) is characterized in that in a first method step a first plastic sheet (6) is applied on the upper side (5) of the surface area (4), then a first layer (8) of gravel (8a) is arranged on the plastic sheet (6), and then the solar modules (2) on the plastic sheet (6) are placed on the first layer (8) of gravel (8a). Furthermore, the invention relates to an arrangement (1) for mounting solar modules (2) on a substantially level surface area (4).

The invention relates to a method and an arrangement for mounting solar modules on a surface area, in particular on the ground, a flat roof or a carport, according to the generic part of claims 1 and 10.

Solar modules are arranged today in large solar farms with several 100 or even 1000 modules in order to feed the photovoltaically obtained energy into the public current network. It is customary here that the solar modules are mounted inclined on frames or stands in order to secure the modules on the one hand against wind suction forces and on the other hand to align the photosensitive upper side of the modules as much as possible at a right angle relative to the incident solar radiation in order to increase the incident photointensity. Although the electrical power gained from the sunlight can be increased to a certain extent by the inclined arrangement of the modules, the arrangement of each module on its own stand or frame is associated with considerable expense due to the associated expense for material and mounting.

In addition, parallel rows of modules may result in one row casting a shadow on or shading the next row given the angle of the incident solar radiation and the inclined arrangement of the modules; this shading disadvantageously reduces the electrical power produced by the modules. To avoid this, the modules may be arranged on the frames separated by up to several meters, which results in a disadvantageous enlargement of the occupied surface area.

Finally, known solar farms have the problem that grass and plants grow underneath the frames as time passes and must be removed in a regular manner in order to prevent the individual modules from growing together and the associated reduction of performance.

Accordingly, the present invention has the task of creating a method and an arrangement for carrying out the method with which photovoltaic solar modules, in particular thin-layer solar modules can be mounted economically and very rapidly on a level surface and operated with a minimum of expense for maintenance.

This task is solved according to the invention by a method and an arrangement with the features of claims 1 and 10.

Other features of the invention are contained in the subclaims.

According to the invention a method for mounting photovoltaic solar modules, which are in particular thin-layer solar modules but can also be traditional, polycrystalline solar modules on a substantially level surface area such as a leveled ground or a sandy surface, a flat roof, a hall roof or also a carport, etc., comprises the following method steps:

At first, a plastic sheet is placed on the level surface, which was optionally roughly leveled in advance with a suitable ground working device such as, e.g., a bulldozer or the like. The plastic sheet is a known sheet which consists, e.g., of polyurethane and is used, for example, in agriculture and in horticulture to prevent the growth of plants such as in particular weeds and grass, etc. settled in the ground. The concept “sheet” also denotes the mat materials sold commercially as weed mats, which are water-permeable so that rainwater can run off into the ground without being hindered.

Next, a first layer of fine gravel is applied onto the first sheet, wherein the concept “fine gravel” also denotes in the present application all gravel-like mixtures such as, for example, the so-called “mineral mixtures”. The preferred grain size of the gravel in the first layer, which can have a minimum thickness between 1 cm and 5 cm or also more, is preferably in a range between 10 and 25 mm.

After the application of the first layer of gravel, the upper side of the layer is drawn off with a suitable tool such as, for example, a rake and planed. This results in the advantage, due to the properties of the gravel, that the upper side of the first layer can also be provided, if desired, with a slight inclination of, e.g., 5° to 10° or even more in order to produce an inclined plane for positioning the solar modules, which favors the flowing off of rainwater from the upper side of the modules. The level placing surface for the solar modules, which was obtained in the previously described manner, is preferably inclined here in the direction of the sun, wherein an additional recess can be optionally introduced in the subsoil at the foot of each inclined surface which serves after being filled with gravel as a runoff channel and/or seepage channel for rainwater. The recess is covered to this end with a water-impermeable sheet so that the rainwater can be conducted by the recess covered with a slight incline in the manner of a channel to a common collection reservoir from which it can be taken, e.g., for cleaning the solar modules as required.

Subsequently to the above, the solar modules are preferably directly placed in rows and at slight intervals of a few centimeters in groups along rows or also adjacent to one another on the plane upper side of the first layer consisting of gravel according to an embodiment. In order to facilitate the placing of the electrical connection lines running to the connection boxes arranged on the bottom of the solar modules, additional recesses can be introduced into the otherwise level upper side of the first gravel layer so that the solar modules rest with the bottom sides preferably over the entire surface on the upper side of the first gravel layer. The electrical lines which connect the connection boxes of the solar modules to each other or to a known converter are covered in the preferred embodiment of the invention with gravel in such a manner that they cannot be recognized from the outside and make handling more difficult.

The invention has the advantage that slight rugosities in the level surface, i.e., e.g., the ground, can be compensated by the gravel in an economical manner with low cost so that a placing of the bottom of the solar modules over their entire surface on the gravel can be ensured. This ensures that the solar modules, in particular in the case of thin-layer solar modules, cannot be raised by wind suction forces of a customary strength. In addition, the invention has another advantage when used with thin-layer solar modules in that the modules are cooled from the bottom by the gravel and the heat generated by the irradiated sunlight can be effectively removed, as a result of which the disadvantage of the effectiveness of the more economical thin-layer solar modules, which is lower in comparison to thick-layer solar modules, can be compensated again.

Another advantage of the solution of the invention is that the sheet effectively prevents a growth of green plants and weeds between and underneath the modules, which significantly reduces the expense—and with it the costs—for the removal of the growth in comparison to the customary solar farms with solar modules arranged on frames.

Another advantage of the invention is that not only the modules but also the gravel and the sheet can still be removed very easily and in an environmentally friendly manner even after several years in order to use the surface for other purposes. Therefore, the sheet can be supplied, e.g., to a thermal evaluation whereas on the other hand the gravel can be used without further preparation either directly as a basis for a new solar system or, however, can be supplied directly to a different use, e.g., as a filling substance in road construction.

In the preferred embodiment of the method of the invention a second intermediate layer of gravel is arranged between the first layer of gravel and the first plastic sheet and a second plastic sheet is arranged between the intermediate layer and the first layer of gravel. The second plastic sheet is, according to a first embodiment of the invention, a previously described, water-permeable sheet or a water-permeable mat material which effectively suppresses the growth of weeds by plant pollen penetrating from above into the gravel layer. However, the second sheet can alternatively also be a water-impermeable sheet.

The gravel in the second intermediate layer preferably has a finer grain than the gravel in the first layer and serves to compensate rugosities in the ground with great precision so that after the placing of the second plastic sheet in the case of a water-impermeable sheet material a water-tight surface which is as level as possible and preferably inclined at an angle of approximately 3° to 5° to the horizontal is produced underneath the first gravel layer over which the rainwater penetrating into the first gravel layer can run off into a suitable, previously cited gutter for being collected in a common reservoir.

In the previously cited embodiment of the invention the upper side of the first layer of gravel is essentially level in the area underneath a solar module and is inclined relative to the horizontal at an angle between 3° and 30°, in particular 5° to 10°.

In order to reliably secure the solar modules even in strong wind areas in which the wind suction forces considerably exceed the customary maximum value, self-hardening plastic foam can be inserted between the upper side of the uppermost gravel layer and the bottom of each module, which ensures that the gravel components are adhered to each other and to a unit with the bottom of the modules, as a result of which the holding forces acting from below on the module can be considerably increased in a simple manner. In particular, an expanding plastic foam known in particular from construction technology, e.g., PU foam, can be used as plastic material.

The previously described embodiments of the invention have the advantage that the modules can be fixed on the surface with low expense, as a result of which, especially when thin-layer solar modules are fabricated with a comparatively low mechanical stability due to the at first expanding and then hardening foam, a very stable support for the modules is created which reliably protects them against breakage. Another advantage can be seen in the fact that in case of a defect, the modules can nevertheless be detached, if necessary, from the gravel-foam composite with low expense in order, e.g., to replace the electronics in the connection boxes.

According to another concept underlying the invention, the solar modules are arranged in an array in at least two parallel, adjacent rows. Here, each two adjacent solar modules lie with their one end on the upper side of the first or second layer of gravel and are preferably supported in pairs with two of their corners on the second end on support elements let into the gravel. The support elements in the preferred embodiment are parallelepipedal concrete stones which are added only into the gravel of the first and/or also of the second layer. The upper side of the support elements can run flush to the upper side of the uppermost layer of gravel in the modules can be secured on the upper side of the support elements, e.g., by the self-foaming plastic material or also by additional holding means, e.g., by metallic sheets or metallic angles. The modules can be inclined in such a manner that the support elements project out of the gravel material so that a wedge-shaped intermediate space is formed underneath the modules.

Furthermore, several modules combined in series to an array can be supported by a carrier construction, e.g., a frame consisting of profiles connected to each other, in particular U-shaped metal profiles, on the upper side of the uppermost gravel layer and/or on the previously described support elements. In addition, the support elements can also be constructed as stand constructions with two or more stands on which the carrier construction, on which the modules are fastened, is supported, creating an inclination of the modules. This opens the possibility, for example, in the case of an East-West alignment of the modules, of obtaining an angle of inclination of, e.g., 16°. In this case, which should be included by the text of the claims, an intermediate space which is wedge-shaped when viewed from the side remains between the bottom of the modules, which run at an incline together with the carrier construction and the frame, and the upper side of the uppermost gravel layer. This intermediate space has a height of, e.g., 1 to 5 cm or more in the area of the lower end and a height of up to 50 cm in the area of the upper end in a module and up to 2 m or more in the case of, e.g., 4 or more modules if they are fastened sequentially on the carrier construction. In the case of another angle of inclination the height of the upper end becomes correspondingly larger or smaller.

Furthermore, it is advantageous in the case of the previously mentioned East-West alignment of the modules if a second carrier construction or as second frame with an appropriate number of modules fastened on it is supported by its one end on the same support elements on which the first frame is also supported by its upper end, whose other, lower end preferably also rests directly on the upper side of the uppermost gravel layer. This results in an arrangement of the two module arrays which is triangular in cross section and can be optionally be repeated as often as desired in order to bridge a surface over the available width without intermediate spaces in the East-West direction.

As a result of the fact that the plant growth is suppressed for a very long time when using the first and/or second gravel layer of the invention in combination with the sheets under the solar modules as previously described, the interval of the carrier construction to the upper side of the uppermost gravel layer can be advantageously reduced down to 0 cm in the area of the lower ends of the modules of the particular array without causing a shadowing by the growth of grass or weeds. Since it is no longer necessary for this reason to remove problematic growth at regular intervals, there is also the possibility that a plurality of arrays of modules are arranged sequentially in pairs and at the same time adjacent to one another in rows on corresponding carrier constructions positioned directly adjacent to each other in order to cover a large surface substantially seamlessly without intermediate spaces.

The invention is described in the following with reference made to the drawings using an arrangement according to the invention for mounting solar modules with reference to the drawings.

In the drawings:

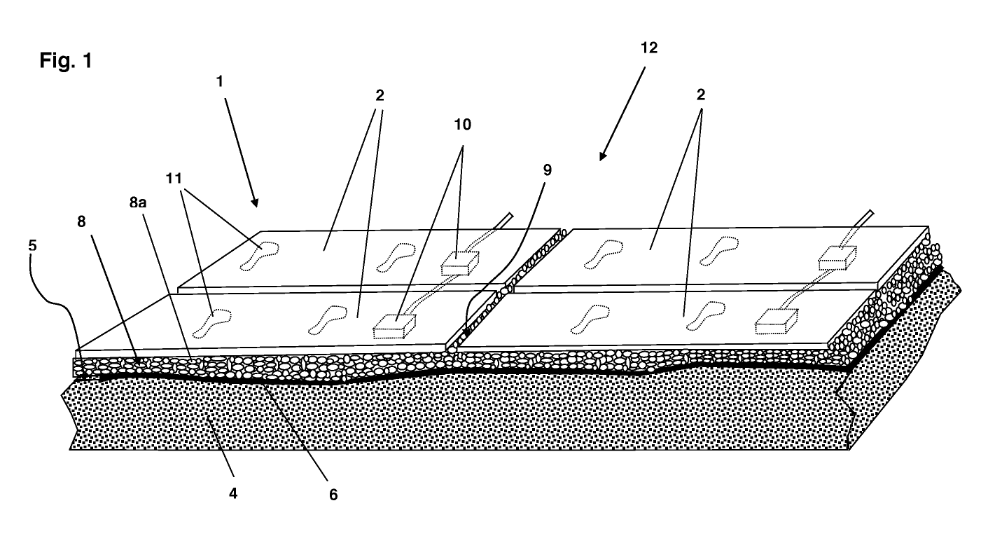

FIG. 1 shows a schematic, three-dimensional partial view of four solar modules arranged according to a first embodiment of the method of the invention on a surface area, and

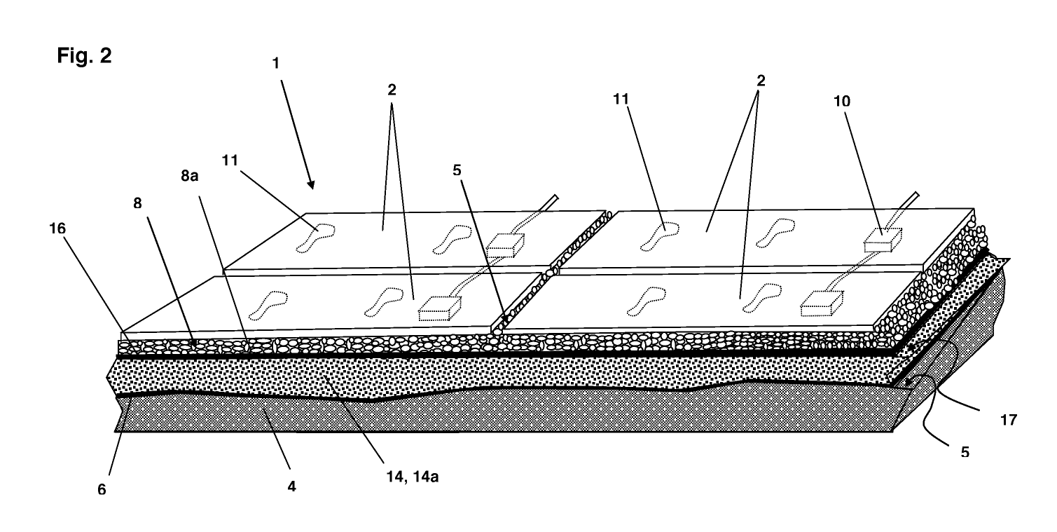

FIG. 2 shows a schematic, three-dimensional view of four solar modules arranged according to a second embodiment of the method of the invention on a surface area.

As is shown in FIG. 1, an arrangement 1 for mounting solar module 2 on a surface area 4 which is, in the case shown, ground which is slightly uneven on its upper side, comprises a first plastic sheet 6 placed on the upper side 5 of the surface area 4 and which covers preferably the entire area in which the solar modules 2 are to be arranged on the surface area 4. A first layer 8 of gravel 8a is arranged on the plastic sheet 6 which layer fills the lower rugosities in the surface area 4 and was leveled on its upper side 9 with a rake or the like (not shown). After the planing of the upper side 9 of the first layer 8, recesses are introduced into gravel 8a in the areas in which the connection boxes 10 and lines 12 of the particular solar modules 2 are present and subsequently the solar modules 2 are deposited sequentially in parallel rows on the gravel 8a so that they rest with their lower side on the entire upper side of the first layer 8.

Accessible path sections are arranged between the preferably U-shaped rows (not shown) in order to clean the modules and, if necessary, to be able to replace defective modules.

In order to firmly connect the modules to the gravel 8a of the first layer 8, the upper side of the first layer 8a is sprayed in a punctiform manner or over the entire surface with a known mounting foam 11 immediately before the placing on of the modules, which foam expands before hardening and as a consequence penetrates approximately 0.5 to 2 cm into the hollow spaces in the gravel 8a and connects the latter to the bottom of the particular module 2.

In order to additionally protect the solar modules 2 against wind and rain, which modules were mounted in the previously described manner in an array 12 on the surface area 4, a protective rampart (not shown) or a wall can be arranged around the entire array 12 and which is economically constructed as a dirt rampart during the direct mounting on the ground or on a grassy area.

In the embodiment of the invention shown in FIG. 2 a second, intermediate layer 14 of gravel 14a is additionally arranged between the first layer 8 of gravel 8a in the first plastic sheet 6, which second, intermediate layer 14 has a finer granulation than that of gravel 8a of the first layer 8. As can be furthermore gathered from the view of FIG. 2, a second plastic layer 16 is arranged between the second intermediate sheet 14 of gravel 14a and the first layer 8 of gravel 8a, which second plastic sheet is a polyurethane sheet or a water-permeable mat material, preferably in the same manner as the first plastic sheet 6. Prior to the placing of the second sheet 16, the upper side 17 of the second intermediate layer 14 of gravel 14a is planed, for example, with a rake and optionally provided with a slight inclination of preferably 3-5° in order to ensure a running off of rainwater along the upper side of the second sheet 16 and which is collected in a collection gutter (not shown) and can be removed by the latter from the area of the array 12. This ensures that no pools form underneath the solar modules 2.

### LIST OF REFERENCE NUMERALS

1 arrangement according to the invention
2 solar module
4 surface area
5 upper side of the surface area
6 first sheet
8 first gravel layer
8a gravel
9 upper side of the first gravel layer
10 connection box
11 plastic foam
12 array of solar modules
14 second gravel layer
14a gravel of the second gravel layer
16 second sheet
17 upper side of the second gravel layer

1. A method for mounting photovoltaic solar modules on a surface area (4) comprising the following method steps:
applying a first plastic sheet (6) on the upper side (5) of the surface area (4),
applying a first layer (8) of gravel (8a) on the plastic sheet (6), and
placing solar modules (2) on the first layer (8) of gravel (8a).

2. The method according to claim 1, further comprising:
placing a second intermediate layer (14) of gravel (14a) between the first layer (8) of gravel (8a) and the first plastic sheet (6), and
placing a second plastic sheet (16) between the second intermediate layer (14) of gravel (14a) and the first layer (8) of gravel (8a).

3. The method according to claim 2 further comprising, fixing the solar modules (2) on the gravel (8a, 14a) with self-hardening plastic foam (11).

4. The method according to claim 3 wherein the upper side (9) of the first layer (8) of gravel (8a) is essentially level in the area underneath a solar module (2) and is inclined relative to the horizontal at an angle between 3° and 30°.

5. The method according to claim 2 wherein the second intermediate layer (14) of gravel (14a) has a substantially level surface inclined relative to the horizontal at an angle between 3° to 10°.

6. (canceled)

7. (canceled)

8. The method according to claim 1 wherein,
the solar modules (2) have an upper end and lower end, and
the solar modules are arranged in parallel, adjacent rows wherein
each row includes at least a first solar module and second solar module (2) lying adjacent to one another with the upper end of each module resting on the upper side of the first or second layer (8, 14) of gravel (8a, 14a), and a support element let into the gravel and supporting adjacent corners of the lower ends of the first solar module and second solar module.

9. The method according to claim 8, wherein the solar modules (2) are fixed on the support elements by holding means.

10. An arrangement for mounting solar modules (2) on a substantially level surface area (4), comprising:
a first plastic sheet (6) placed on the upper side (5) of the surface area (4),
a first layer (8) of gravel (8a) arranged on the plastic sheet (6),
a layer of solar modules (2) disposed on the first layer of gravel.

11. The arrangement according to claim 10, further comprising:
a second intermediate layer (14) of gravel (14a) arranged between the first layer (8) of gravel (8a) and the first plastic sheet (6), and
a second plastic sheet (16) is arranged between the second intermediate layer (14) of gravel (14a) and the first layer (8) of gravel (8a).

12. (canceled)

13. The arrangement according to claim 10, wherein the solar modules (2) are arranged in an array (12) with a plurality of adjacent solar modules (2).

14. The arrangement according to claim 13 wherein a plurality of solar modules (12) are arranged sequentially in pairs and at the same time adjacent to each other in rows on appropriate carrier constructions and positioned directly adjacent to each other on the upper side of the gravel layer (8, 14).

15. The arrangement according to claim 13, wherein the array (12) is protected at least on one side against the direct effect of wind and rain by a protective rampart or a wall.

16. The method according to claim 3 wherein the self-hardening plastic foam (11) is a PU-foam.

17. The method according to claim 3 wherein the upper side (9) of the first layer (8) of gravel (8a) is essentially level in the area underneath a solar module (2) and is inclined relative to the horizontal at an angle between 5° to 10°.

18. The method according to claim 8—wherein the gravel comprises parallelepipedal concrete stones.

19. The method according to claim 9 wherein the holding means—are at least one of metallic sheets or metallic angles.
